(19) United States
(12) Patent Application Publication
(10) Pub. No.: US 2009/0013538 A1
(43) Pub. Date: Jan. 15, 2009

(54) CUTTING INSTRUMENT

(75) Inventors: Richard S. Constantine, Milford, CT (US); Michael E. Peterson, Fairfield, CT (US)

Correspondence Address: WHYTE HIRSCHBOECK DUDEK S.C.;INTELLECTUAL PROPERTY DEPARTMENT, 33 East Main Street, Suite 300, Madison, WI, 53703-4655, US

(73) Assignee: ACME UNITED CORPORATION, Fairfield, CT (US)

(21) Appl. No.: 12/060,063

(22) Filed: Mar. 31, 2008

Related U.S. Application Data
(60) Provisional application No. 60/908,843, filed on Mar. 29, 2007.

(51) Int. Cl. B26B 13/00; B29C 70/06

(52) U.S. Cl. 30/254; 30/165; 264/258

(57) ABSTRACT

A new and improved cutting instrument is disclosed, having a strong rigid exoskeleton. The exoskeleton is made of a fiber and resin matrix, such as a carbon fiber weave. The carbon fiber exoskeleton can be applied to a scissors handle for increased cutting performance.

### CROSS REFERENCE TO RELATED APPLICATIONS

This application claims priority to U.S. provisional patent application Ser. No. 60/908,843, titled “Cutting Instrument” and filed on Mar. 29, 2007, which is incorporated by reference in its entirety herein.

### FIELD OF THE INVENTION

The present invention relates to improved cutting instruments. More particularly, the present invention relates to cutting instruments having improved structural rigidity and energy transfer for improved cutting performance.

### BACKGROUND OF THE INVENTION

Cutting instruments include, by example, scissors, knives, and paper trimmers, each of which can have varied uses. Regardless of the cutting instrument, increased rigidity and light-weight features can positively affect cutting performance. Advanced materials have been used to enhance the cutting performance, including tough, hard titanium coatings as described in U.S. Development of new materials and treatments continue to provide sources of innovation for the cutting instrument industry.

In the production of fiber composite materials, reinforcing fibers are usually employed in the form of continuous fibers (filaments and filament yarns), short fibers, short fiber bundles, or in the form of sheet-like structures (e.g. as woven fabric, knitted fabric, loop-knit fabric, or non-wovens).

The mechanical properties of fiber-reinforced materials are also a function of the fiber length, the fiber length distribution, and the fiber strand count. Fiber reinforced composites consisting of reinforcing fibers and a matrix resin are widely used for sporting goods such as golf club shafts, fishing rods, tennis rackets and the like. Such composites are also used in the aerospace industry and other general industries since they are light in weight and excellent in strength and mechanical properties.

Fiber reinforced composites are often produced by various methods and, at present, to produce them by using sheet-like intermediate materials called prepregs in which reinforcing fibers are impregnated with a matrix resin. According to these methods, a plurality of prepreg sheets are laminated and heated to form a fiber reinforced composite.

In recent years, sporting goods such as golf shafts and fishing rods are remarkably reduced in weight, and prepregs suitable for light-weight design are being demanded. Prepregs using high modulus fibers, especially high modulus carbon fibers as reinforcing fibers have been demanded in recent years since they facilitate lighter-weight design. Furthermore, the demand for prepregs with a high reinforcing fiber content is also growing.

Golf shafts and fishing rods are formed by winding prepregs around a mandrel with a relatively small diameter. If the force to delaminate a prepreg laminate exceeds the tackiness between the laminated sheets of the prepreg, the prepreg wound around a mandrel is delaminated, which disturbs the winding work. The force to delaminate the prepreg is larger if the drapability is smaller. Therefore, even if tackiness is improved at the sacrifice of drapability, the mandrel winding work itself cannot be improved significantly. A sample of these processes are provided by U.S. Pat. No. 6,287,696, Resin composition for a fiber reinforced composite, a prepreg and a fiber reinforced composite, hereby incorporated by reference, including all references and documents cited therein.

Various methods improve the features of a prepreg include adding a polymer such as a thermoplastic resin or an elastomer to an epoxy resin. Methods of adding a polymer to an epoxy resin include methods of adding a polyvinyl formal resin as stated in JP-A-58-8724 an JP-A-62-169829, methods of adding a polyvinyl acetal resin as stated in JP-A-55-27342, JP-A-55-108443 and JP-A-6-166756, a method of adding a polyester polyurethane as stated in JP-A-5-117423, a method of adding a poly(meth)acrylate polymer as stated in JP-A-54-99161, a method of adding a polyvinyl ether as stated in JP-A4-130156, a method of adding a nitrile rubber as stated in JP-A-2-20546, all of which are hereby incorporated by reference in their entirety herein.

Cutting instruments, such as scissors, often employ rigid cutting blades and rigid handles. The materials used for both the blades and the handles affect cutting performance by altering transfer of energy to the cuffing edge. Rigid handles have been made of various plastics, such as ABS, and various composite materials. By example, thermoplastic and thermoset polymers filled with glass fibers have been used to form moldable handles. It would be advantageous to provide a lightweight and extremely rigid cutting instrument that provides increased energy transfer through the handle to the cutting blade. It would be further advantageous to provide a pre-manufactured cutting instrument that can be modified to form a rigid exoskeletal structure that significantly increases the rigidity and cutting performance of the cutting instrument. It would be advantageous to provide a cutting instrument with extreme toughness and reduced likelihood of breaking under all levels of stress. Furthermore, it would be advantageous for a exoskeletal structure to include woven carbon fiber fabric. It would be even more advantageous to provide a low cost highly scalable manufacturing method for providing such an improved cutting instrument.

### BRIEF DESCRIPTION OF THE DRAWINGS

FIG. 1 is a side view of a scissors in accordance with at least one embodiment of the present invention;

FIG. 2 is an opposite side view of the scissors in FIG. 1;

FIG. 3 is a cross sectional view taken along line 3 of the scissors depicted in FIG. 2;

FIG. 4 is a cross sectional view taken along line 4 of the scissors depicted in FIG. 2;

FIG. 5 is a cross sectional view of the thumb bow of a scissors in accordance with at least one embodiment of the present invention;

FIG. 6 is a cross section of a woven fiber sheet incorporated within at least one embodiment of the present invention;

FIG. 7 is a cross section of a woven fiber sheet incorporated within at least one embodiment of the present invention;

FIG. 8 is a perspective view of a scissors in accordance with at least one embodiment of the present invention;

FIG. 9 is an exploded view of the scissors shown in FIG. 8;

FIG. 10 is an exploded view of a scissors assembly shown in FIG. 8;

FIG. 11 is a cross section of the scissors shown in FIG. 8 limited to one blade assembly; and

FIG. 12 is a blown up view of the cross sectional view in FIG. 11.

### DETAILED DESCRIPTION OF THE INVENTION

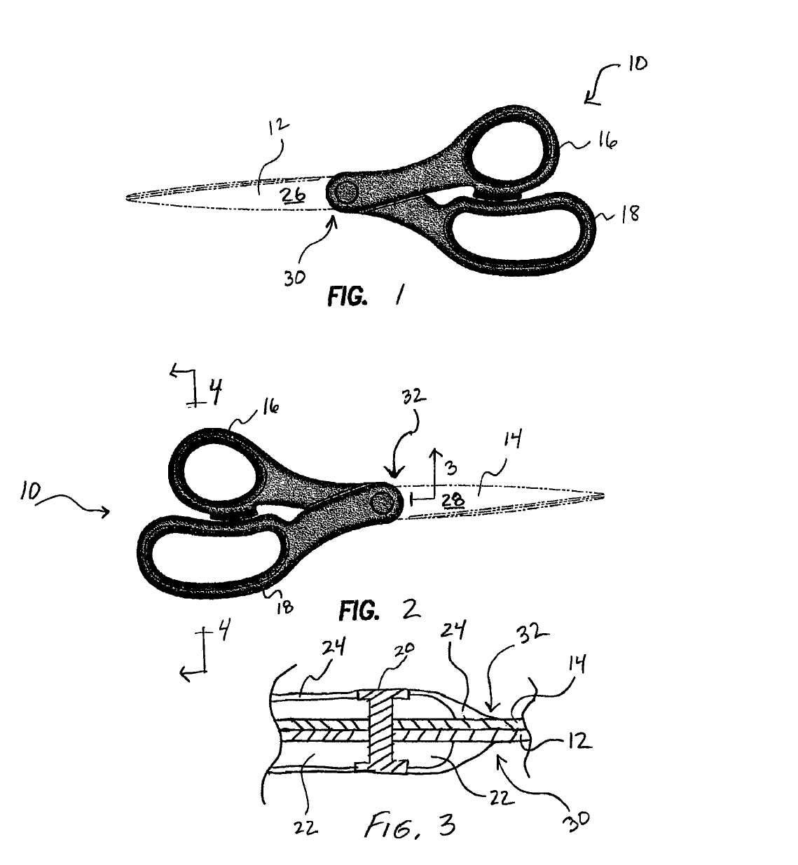

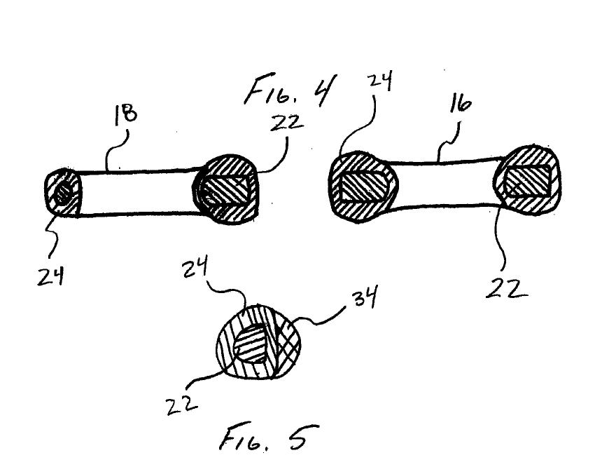

Briefly, in one aspect of the invention a scissors 10 is provided (FIG. 1-2). The scissors 10 comprises a pair of complementary cutting blade assemblies 12,14, a pair of handles 16,18 integrally formed with respective blade assemblies 12,14, and a pivot 20 for rotationally connecting the blade assemblies 12,14.

Referring to FIG. 3, a cross sectional view of the handles 16,18 is provided. The handles 16,18 have an endoskeleton 22, and an exoskeleton 24. The endoskeleton 22 can be manufactured from a variety of moldable and non-moldable materials, including ABS plastic, glass-filled nylon, metal, foam, semi-solid materials, polypropylene, and polycarbonate. Alternatively, the endoskeleton can be formed from more than one material, a composite material, and/or a uniform material, such as a metal.

The exoskeleton 24 is formed from a carbon fiber weave and resin matrix. A strong light weight endoskeleton 22 in combination with an even stronger and lighter weight exoskeleton 24 provides a cutting instrument with improved rigidity and transfer of power through the cutting blades. As a result, improved cutting performance with out undue added weight is provided. Though not clearly depicted within the provided figures, the carbon fiber and resin matrix provides an aesthetically pleasing cutting instrument. Carbon fibers are often found in black, which provides for a dark grey or light black partially translucent appearance when combined with resin. The carbon fiber material can be formed of varying colors and patterns. Weave patterns can contain criss-crossing patterns of varying colors, thereby providing decorative effect or a functional purpose.

The exoskeleton 24 meets the blade surface 26,28 at juncture 30,32. The juncture 30,32 provides a sealed joint between the exoskeleton 24 and the blade surface 26,28. Such a juncture 30,32 is advantageous for use in sterile environments as well as with food preparation instruments, where sanitation is of great importance. Having a sealed handle provides significant functional advantage for the floral as well as the lawn and garden industries. The seal inhibits botanical and various other germs, bacteria, and particulate matter from being trapped within crevasses and unwantingly transferred. This is of particular interest for floral uses, as some plants and/or flowers may not react well with the substances found on or within other plants and/or flowers. Providing a sealed juncture 30,32 additionally provides a direct transfer of energy from the handles 16,18 to the blade assemblies 12,14.

Referring to FIG. 4, a cross sectional view of the instrument 10 is provided. The endoskeleton 22 and exoskeleton 24 are clearly shown. Handles 16,18 generally have a smooth outer surface, which provide reduced user skin irritation as compared to various composite materials known in the art. Additives and/or handle surface treatments can alternatively provide a handle with greater surface roughness. In an alternative embodiment (FIG. 5), a gripping layer 34 is provided. The layer 34 can be a material expressing a variety of tactilely pleasing and/or functional features. Layer 34 can be a flexible overmold material in conjunction with the exoskeleton 24 for increased comfort, reduced fatigue and increased gripping. The overmold can be formed over the entire exoskeleton 24 or formed only over the gripping regions. The overmold material can be a Microban® or similarly microbially resistant material.

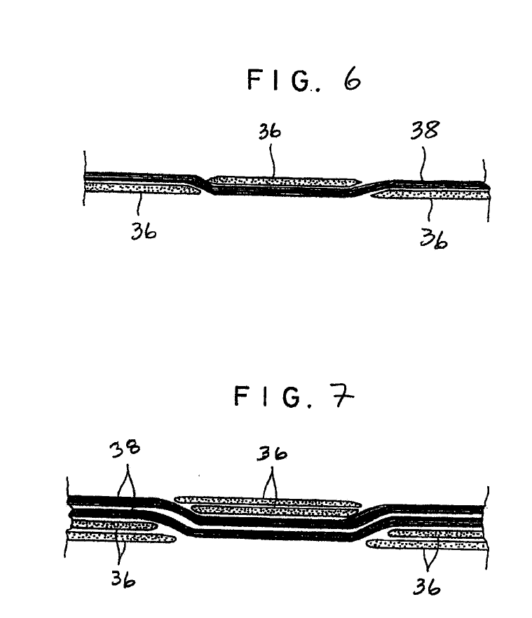

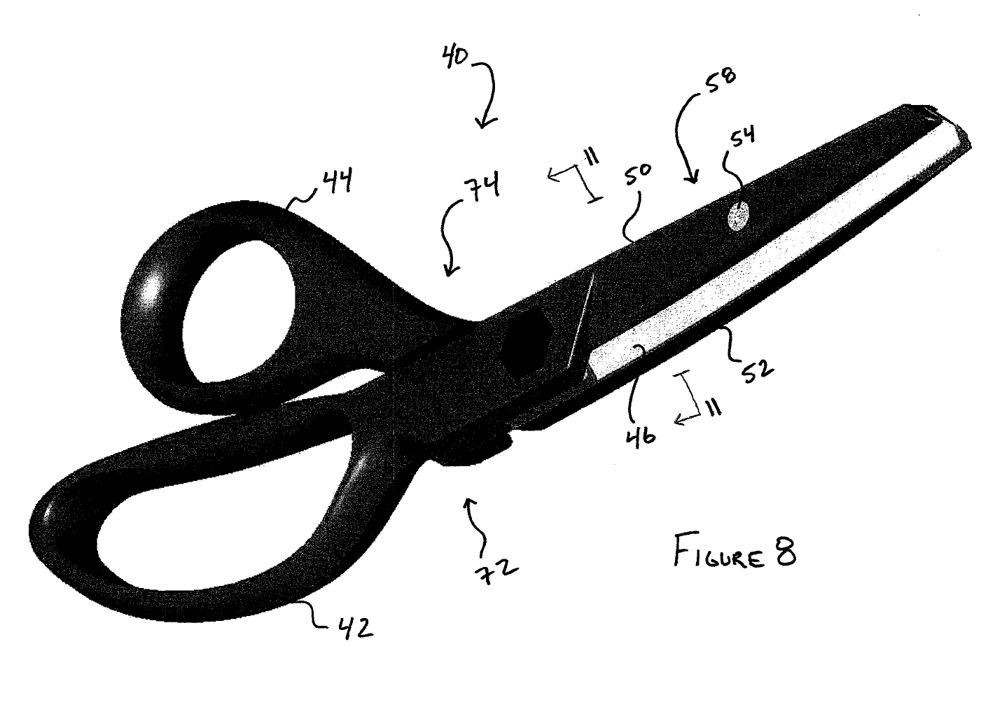

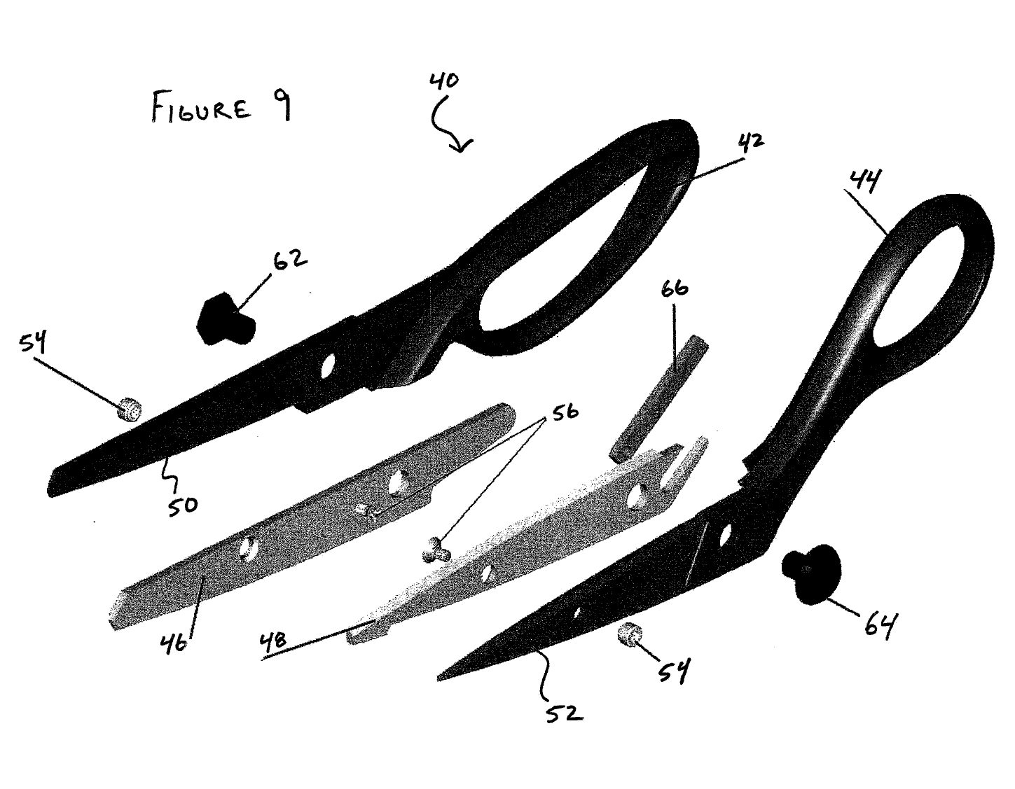

Referring to FIGS. 6-7, cross-sectional views of carbon fiber fabric for use within the exoskeleton is provided. The carbon fiber woven fabric includes a first 36 and second 38 flat carbon fiber yarn. The fabric is shown with a single layer of both first 36 and second 38 yarn threads (FIG. 6) and with two layers of each first and second yarn threads (FIG. 7). It is contemplated that more than two (2) layers of each first 36 and second 38 yarn threads can be utilized. More than one layer or application of a resin or polymer matrix can be used to bind two (2) or more layers of the carbon fabric. It is further contemplated that an unequal number of first 36 and second 38 yarn threads be employed with the present invention. By example, twice as many or greater first 36 yarn threads may be used than second 38 yarn threads in locations of the instrument 10 that require greater longitudinal or lateral strength and/or rigidity. In an alternative embodiment, two separate carbon fiber fabric layers can be used, wherein the fabrics are of varying weave and fiber dimensions.

In at least one embodiment, the carbon fiber yarn to be used has a yarn size in a range of about 2,000 to about 40,000 deniers, a yarn width of about 3 to 20 mm, a yarn thickness of about 0.02 to about 1.0 mm, and a ratio of yarn width to yarn thickness of about 2 to about 300. In another alternative embodiment, the physical yarn parameters are less than and/or greater than the values provided above. In yet another alternative embodiment the carbon fiber yarn has a substantially circular cross section.

It is further contemplated that the instrument 10 is not a pair of scissors. The instrument 10 can alternatively be a single blade cutting instrument. By example, the cutting instrument 10 can be selected from a variety of trimmers, knives, letter openers, utility knives, hole punches, pencil sharpeners, or rotary paper trimmers. The instrument 10 can be selected from a variety of cutting instruments for which wear resistance, toughness, hardness, and structural rigidity improve the operability of the instrument. These properties provide a cutting instrument having increased longevity and greater resistance to wear and/or failure. The endoskeleton 24 reduces compression and flex, without adding undue weight. The enhanced compressibility features provide for a substantially indestructible combination, under normal working environments.

By example, a guillotine trimmer (not shown) having a cutting arm with a carbon fiber exoskeleton provides a light weight and strong arm, which efficiently transfers energy from the arm through the pivot to the cutting edge. Greater cutting performance is achieved with less effort due to weight savings and rigidity of the arm. The trimmer base can also contain carbon fiber which increases rigidity and allows the trimmer to be transported with greater ease. A cutting and measuring surface can be completely manufactured from a carbon fiber matrix or limited to the surface perimeter, in order to avoid damage to the matrix due to user cutting action. In yet another alternative embodiment, the carbon fiber exoskeleton can be formed with a traditional ruler, the ruler having an integrated metal edge on at least one edge of the ruler.

Alternatively, the carbon fiber weave, braid, and/or single fibers are purposefully oriented upon the placement of the carbon fiber matrix with respect to the specific handle or blade assembly location for enhanced energy transfer. It is contemplated that a variety of handle 16,18 and blade assembly 12,14 configurations will be employed, having a variety of exoskeleton 24 arrangements. Depending upon the physical characteristics and uses of the instrument 10, the exoskeleton 24 can be altered to provide optimal performance features. Furthermore, it is contemplated that highly contoured endoskeleton 22 surfaces are provided with a rigid exoskeleton 24 as described above. By example, an embodiment of the present invention includes ergonomic handles and cutting instrument surfaces having multiple contours.

Alternatively, the carbon fiber fabric can be a web-laid sheet containing fibrillated acrylic fiber, and an activated carbon constituent selected from the group consisting of activated carbon fiber, activated carbon particles, and mixtures of activated carbon fiber and activated carbon particles. It is further contemplated that carbon nanotubes be used in place of and/or in combination with carbon fiber yarns.

While defined orientations of the filaments are aimed for in the processing of filaments and filament yarns as well as the processing of sheet-like structures (filament winding, laying of resin-impregnated or thermoplastic-impregnated woven fabrics or felts or other sheet-like structures in molds with shaping and curing), the materials reinforced with short fibers can have an orientation influenced by the processing method (alignment of the short fibers by flowing in the mold during injection molding or pressing) and a fiber length distribution determined by the production of the material (for example in the production of fiber-reinforced thermoplastics by drawing in rovings, that is to say filament bundles, in a mixing kneader or an extruder). It is contemplated that shreaded or particulate carbon fibers can be combined with a resin matrix to provide for a moldable exoskeleton 24. A preconfigured mold can be manufactured that provides for different fiber filament orientation based upon placement of the intake apertures with respect to the instrument configuration. As the moldable carbon fiber matrix material enters the intake apertures orientation of the fiber are controlled by the amount of matrix material flowing within each aperture as well as the location of the aperture. Alternatively, the preconfigured mold provides a exoskeleton having random fiber orientation.

In accordance with at least one embodiment of the invention a carbon fiber weave is applied to a scissors 10, 40. The size of the fiber used for forming the endoskeleton 24, 70 is determined and a coarse weave sheet is made by a fiber weaving machine. The fiber sheet is cut to proportions suitable for encompassing the endoskeleton and then wrapped around and fixed to the endoskeleton with a suitable glue. A second fiber layer can be added with the same process directly over the first layer. The scissors 10, 40 is then coated with an epoxy resin and then formed in a compression machine, followed by a heating process. The heating process varies depending upon the resin, but can be for 150 minutes at 125 C. A final polishing step occurs after the scissors 10, 40 is removed from the heating process. In an alternative embodiment more than two layers, or merely a single layer of carbon fiber weave is applied to the endoskeleton. By example, the first layer is a glass fiber sheet of approximately 0.1 mm thickness and the second layer is a carbon fiber sheet of approximately 0.3 mm. Alternatively, the carbon fiber sheet can range from about 0.05 mm to about 0.5 mm in thickness. It is further contemplated that the carbon fiber sheet is less than 0.05 mm in thickness and greater than 0.5 mm in thickness.

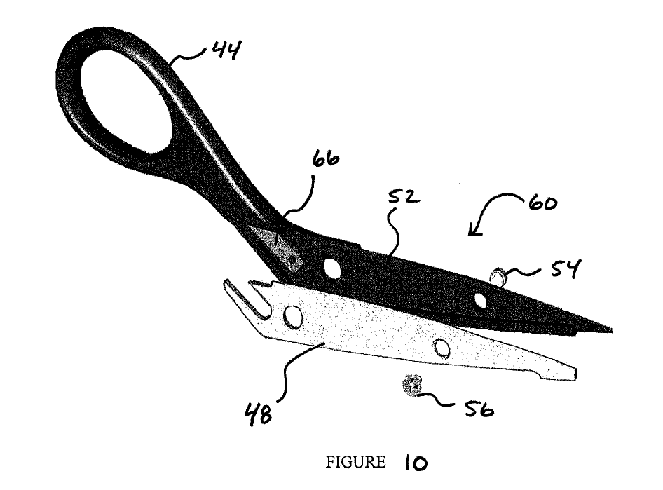

Now referring to FIGS. 8-10 showing an alternative embodiment scissors 40 having a finger bow 42, a thumb bow 44, cutting blades 46, 48, and blade supports 50, 52. The bows 42, 44 and supports 50, 52 are integrally formed. The blades 46, 48 are attached to the supports 50, 52 through a nut 54 and screw 56 configuration. The blade 46, 48 and blade support 50, 52 when assembled is collectively referred to as a blade assembly 58, 60. The blade assemblies 58, 60 are connected to each other through a nut 62 and bolt 64 configuration. The nut 62 and bolt 64 configuration can be fixed, such as a rivet or configured for tensioning. In the tensioning configuration the nut 62 and bolt 64 can be configured for use with a particular tool system selected from the group comprising hex nut, Phillips head, and Torx head. Scissors 40 can be configured for easy replacing of the blades 46, 48, which can be removed for sharpening or for using alternately configured blades. The blade assembly 60 can have a support 66 integrated with and between the bow 44 and the support 52. Combination of the bow 42 and blade assembly 58, as well as the bow 44 and blade assembly 60 are referred to as the scissor assemblies 72, 74 respectively.

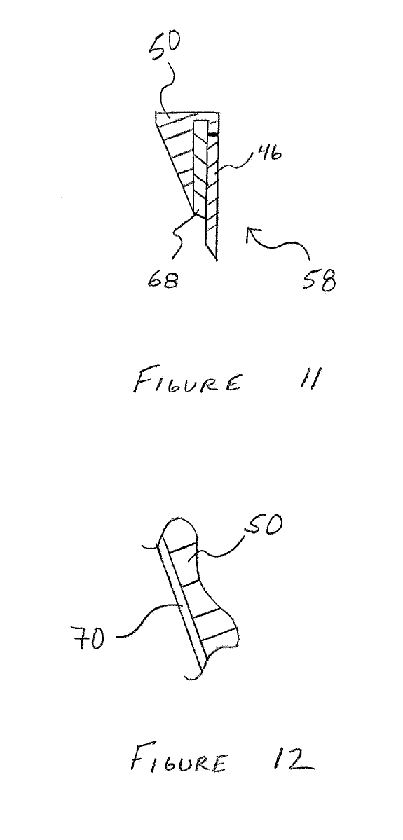

Referring to FIGS. 11 and 12, a cross section of the blade assembly 58 is provided. The blade assembly further comprises a blade spacer 68. The blade assemblies 58, 60 have a carbon fiber and resin matrix exoskeleton 70. The blades 46, 48 are made of a rigid material, such as steel, metal alloy, ceramics, or a combination thereof. In an alternative embodiment, the blade assemblies have a tubular structure proximal to the handles 42, 44. The tubular structure provides improved energy transfer from the handles to the blade edges. The tubular structure can be solid or hollowed. The tubular structure also reduces flex within the blade assembly, thereby improving cutting performance. The exoskeleton 70 can be formed after the nut 54 is fit into the support 50, such that a uniform and more pleasing appearance is provided, in addition to greater structural rigidity of the nut 54 and screw 56 arrangements. It is further contemplated that the blades have a tough, wear resistant coating, for example a coating comprising titanium nitride and chromium nitride, and/or titanium chromium nitride.

Matrix resins used for the exoskeleton can include both thermosetting resins and thermoplastic resins. Epoxy resins (cured) can be used since they have excellent mechanical and chemical properties such as heat resistance, stiffness, dimensional stability and chemical resistance. The commonly used terms “thermosetting resin” and “epoxy resin” include two cases: 1) a prepolymer and 2) a cured product obtained by reacting a composition containing the prepolymer and other ingredients. In the present specification, the terms “thermosetting resin” and “epoxy resin” are used to mean a “prepolymer” unless otherwise stated. One skilled in this art will appreciate that the term matrix resin is intended to mean essentially any resin having the cured or polymer characteristics of the exemplary resins described herein. This appreciation extends to resins or polymers presently known as well as those hereafter developed. One will also understand and appreciate that while carbon fibers are extensively discussed herein, carbon fiber is merely exemplary and not limiting of this invention.

In at least one embodiment of the present invention, the handles are formed by first determining the size of carbon fiber material. Once chosen, the carbon fiber material is woven into a coarse woven sheet through use of a carbon fiber weaving machine. The carbon fiber woven fabric is dynamically cut and configured for wrapping over a preexisting instrument handle or endoskeleton. Alternatively, the fabric can be placed over the pre-existing handle and excess fabric can be cut after the fabric is affixed to the endoskeleton handle. The fabric can be adhered to the endoskeleton through use of various glues, adhesives, or binding agents. In an alternative embodiment, two or more layers of carbon fabric are formed over the endoskeleton. After the fabric is affixed to the handle, an epoxy resin is applied to the fabric. The resin can be applied through a variety of processes, including spraying, brushing, and molding. Molding the resin on to the carbon fiber occurs by injecting the resin into a mold subsequent to placing the carbon fiber wrapped endoskeleton within the mold. The epoxy resin is cured with the carbon fabric by heating the combination in a range of about 100 minutes to about 300 minutes at a temperature in a range of about 90 C to about 200 C. After the instrument has been removed from the heating oven a final polishing process occurs when necessary in order to provide the optimal aesthetic appearance. Alternatively, the resin and/or polymer matrix with carbon fiber can be cured at a temperature less than about 90 C. By example, various formulations are contemplated that allow curing at room temperature.

In an alternative embodiment, the cutting instrument exoskeleton is formed over a semi-solid and/or moldable endoskeleton. Light weight materials such as extruded polystyrene and expanded polystyrene can be utilized as an endoskeleton, over which a carbon fiber matrix is formed. The carbon fiber matrix includes a weave, braided, fabric, or wound configuration, along with a resin and/or polymer matrix as described herein. After the carbon fiber matrix is applied to the endoskeleton, the cutting instrument is placed within a prefabricated mold or mechanical stamp. Pressure is applied to the endoskeleton/exoskeleton combination, thereby forming the desired shape and configuration of the handles and/or structure of the cutting instrument. This process can be used to enhance mass manufacture and production of the cutting instruments.

In an alternative embodiment, a moldable matrix can be formulated including glass fiber and carbon fiber. This matrix can be extruded into a mold for forming the cutting instrument. In yet another alternative embodiment, the matrix includes graphite, Kevlar®, glass, carbon, or any combination of these materials in fiber and/or particulate form.

In an alternative embodiment, carbon fiber is individually woven over the endoskeleton 22 and subsequently cured with a resin as described above. In yet an another alternative embodiment, the exoskeleton 24 is formed by wrapping the carbon fiber around the endoskeleton and adhering pre-woven carbon fabric to the endoskeleton 22, followed by the curing process with a suitable resin material. In yet another alternative embodiment, a resin or polymer matrix binding material can be applied to the woven carbon fabric or non-woven carbon fibers prior to combining it with the endoskeleton 22 or other substrate material.

It is specifically intended that the present invention not be limited to the embodiments and illustrations contained herein, but include modified forms of those embodiments including portions of the embodiments and combinations of elements of different embodiments as come within the scope of the following claims.

What is claimed is:

1) A cutting instrument comprising:
a cutting blade integrally formed with a handle, the handle comprising an exoskeleton and a core, the exoskeleton comprising a carbon fiber and resin matrix.

2) The cutting instrument of claim 1 wherein the carbon fiber is woven carbon fiber.

3) The cutting instrument of claim 2 wherein the woven carbon fiber is suspended in a polymer matrix.

4) The cutting instrument of claim 1 wherein the exoskeleton comprises carbon fiber filaments suspended in a polymer matrix.

5) The cutting instrument according to claim 1, wherein the instrument is selected from a group consisting of paper trimmer, letter opener, utility knife, hole punch, pencil sharpener, rotary paper trimmer, and anvil style paper trimmer.

6) The cutting instrument according to claim 1 wherein the instrument is selected from the group including of paper trimmers, knives, guillotine trimmers, letter opener, shears, utility knife, scissors, hold punch, pencil sharpener, and rotary paper trimmer.

7) A method for forming a carbon fiber reinforced cutting instrument; comprising:
placing the blade assembly within a mold, the mold having injection apertures placed for particular fiber matrix orientation;
injecting a moldable material into the mold for forming a handle, the moldable material comprising a carbon fiber and resin matrix; and
curing the moldable material.

8) A scissors comprising:
a first scissor assembly comprising a first blade assembly integrally formed with a finger bow and a second scissor assembly comprising a second blade assembly integrally formed with a thumb bow, the scissor assembly having an exoskeleton;
a connection means for pivotally connecting the first scissor assembly to the second scissor assembly, wherein the first blade assembly includes a replaceable blade.

9) The scissors according to claim 8, wherein the exoskeleton is a fiber and resin matrix.

10) The scissors according to claim 8, wherein the fiber is selected from a group consisting of woven carbon fiber fabric, glass fiber, fibrillated acrylic fiber, activated carbon particles, and a mixture of activated carbon fiber, activated carbon particles and carbon nanotubes.

11) The scissors according to claim 8, the second blade assembly includes a replaceable blade.
